(19) United States
(12) Patent Application Publication
(10) Pub. No.: US 2026/0266166 A1
(43) Pub. Date: Sep. 10, 2026

(54) UPGRIDDING SUBSURFACE RESERVOIR MODELS

(71) Applicant: Saudi Arabian Oil Company, Dhahran (SA)

(72) Inventors: Oshokhayamhe Ilamah, Dhahran (SA); Ibrahim Saleh Lajam, Dhahran (SA)

(21) Appl. No.: 19/074,981

(22) Filed: Mar. 10, 2025

(51) Int. Cl. E21B 43/16

(52) U.S. Cl. CPC E21B 43/16; E21B 2200/20

(57) ABSTRACT

This disclosure describes systems and methods for upgridding a reservoir model for a subsurface formation. A fine-scale grid for the reservoir model is reshaped to reduce a dimensionality of the fine-scale grid. A graph is generated indicating connections between cells in the reshaped fine-scale grid. The connections are based on values of properties of the subsurface formation associated with the cells. Characteristic vectors of the graph are determined where a length of the characteristic vectors represents a number of vertical layers in the fine-scale grid. The characteristic vectors are clustered. Each cluster represents contiguous layers of cells in the fine-scale grid. A coarse grid is generated by merging cells in the fine-scale grid based on the contiguous layers in each cluster. A reservoir simulation is performed using the coarse grid; and based on the reservoir simulation, regions in the subsurface formation are identified for hydrocarbon production activities.

### TECHNICAL FIELD

The present disclosure relates to methods and systems for modeling hydrocarbon reservoirs in subsurface formations.

### BACKGROUND

Reservoir modeling and simulation are important aspects of hydrocarbon exploration and production activities. Reservoir models are useful for understanding fluid behaviors in a subsurface formation to improve extraction and recovery of hydrocarbons. Reservoir models include a detailed representation of the subsurface formation including geological, geophysical, and petrophyscial properties of the subsurface formation obtained, for example, from well logs, core samples, and/or seismic surveys. Example properties include porosity, permeability, and fluid saturation.

### SUMMARY

Geological models (e.g., geostatic models) form the basis for reservoir models. Geological models often include fine-scale grids with detailed properties of the subsurface formation. Reservoir models can use coarser grids than the geological models to improve computational efficiency of reservoir simulations by reducing computational time and resources to run the reservoir simulation. Generating coarse reservoir model grids can include an upgridding process (e.g., generating a grid with larger elements than the fine-scale grid), an upscaling process that includes mapping the properties from the fine-scale grid of the geological model to the coarse grid, and validating the static parameters and dynamic responses of the coarse grid against the static parameters and dynamic responses of the fine-scale grid.

This disclosure describes systems and processes for upgridding a reservoir model to improve computational efficiency of reservoir simulations. This approach can be used for aggressive upscaling of large reservoir models while preserving essential geological detail of the subsurface formation resulting in faster and more reliable reservoir simulations. This upgridding process considers the structure of the fine-scale grid, a desired coarse grid cell and/or layer count, and the similarity of properties of adjacent fine grid cells. This approach adaptively groups adjacent fine-scale grid cells or layers with similar property values to maintain heterogeneity of the reservoir model thereby improving reliability of the coarse-scale model as compared with a coarse model upgridded based on the structure of the fine-scale grid alone.

In example implementations of this approach, a data processing system (e.g., a computer or control system) can reshape a fine-scale grid for a reservoir model of a subsurface formation to reduce a dimensionality of the fine-scale grid. The data processing system can generate a graph indicating connections between cells in the reshaped fine-scale grid. The connections are based on values of one or more properties of the subsurface formation associated with the cells in the fine-scale grid. The data processing system can determine characteristic vectors of the graph where a length of the characteristic vectors represents a number of vertical layers in the fine-scale grid. The data processing system can cluster the characteristic vectors, where each cluster represents contiguous layers of cells in the fine-scale grid. The data processing system can generate a coarse grid by merging cells in the fine-scale grid based on the contiguous layers in each cluster to reduce the number of vertical layers. The data processing system can perform a reservoir simulation using the coarse grid; and the data processing system can identify one or more regions in the subsurface formation for hydrocarbon production activities based on the reservoir simulation. The one or more regions can be locations within the subsurface formation having properties associated with a presence of hydrocarbons.

Implementations of the systems and methods of this disclosure can provide various technical benefits. The described systems and processes improve the computational efficiency of reservoir simulations by decreasing the number of elements in the simulation as compared to a fine-scale grid or a coarse grid not adaptive to the heterogeneity of the subsurface formation. For example, the described systems and methods can decrease the computational time to run a simulation by 2 to 10 times while achieving similar levels of accuracy as compared with conventional methods of upgridding and upscaling. The described systems and methods enable more aggressive coarsening of model grids as compared with uniform upgridding methods while achieving similar levels of accuracy. Alternatively, the described systems and methods can achieve higher levels of accuracy with similar levels of coarsening. The described systems and methods preserve more geological heterogeneity of the subsurface formation resulting in improved reliability of reservoir simulations using coarse grids as compared to reservoir simulations using uniformly upgridded coarse grids.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 is a schematic illustrating an example wireline operation in a subsurface formation.

FIG. 2 is a block diagram of an example system for upgridding a subsurface reservoir model.

FIG. 3 is an example process for upgridding a subsurface reservoir model.

FIGS. 4A-4E compare an adaptively coarsened grid to a uniformly coarsened grid based on the quality of the respective coarse grids compared with a fine-scale grid.

FIGS. 5A-5H illustrate multiple coarse grid realizations with varying numbers of vertical layers.

FIG. 6 is a plot of the quality of the coarse grids of FIGS. 5A-5H.

FIG. 7A illustrates an example fine-scale three-dimensional (3D) reservoir model.

FIG. 7B illustrates an example coarse 3D reservoir model upgridded from the fine-scale grid in FIG. 7A according to some implementations.

FIG. 8 illustrates hydrocarbon production operations that include field operations and computational operations, according to some implementations.

FIG. 9 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Geological models (e.g., geostatic models) form the basis for reservoir models. Geological models often include fine-scale grids with detailed properties of the subsurface formation. Reservoir models can use coarser grids than the geological models to improve computational efficiency of reservoir simulations by reducing computational time and resources to run the reservoir simulation. Generating coarse reservoir model grids can include an upgridding process (e.g., generating a grid with larger elements than the fine-scale grid), an upscaling process that includes mapping the properties from the fine-scale grid of the geological model to the coarse grid, and validating the static parameters and dynamic responses of the coarse grid against the static parameters and dynamic responses of the fine-scale grid.

This disclosure describes systems and processes for upgridding a reservoir model to improve computational efficiency of reservoir simulations. This approach can be used for aggressive upscaling of large reservoir models while preserving essential geological detail of the subsurface formation resulting in faster and more reliable reservoir simulations. This upgridding process considers the structure of the fine-scale grid, a desired coarse grid cell and/or layer count, and the similarity of properties of adjacent fine grid cells. This approach adaptively groups adjacent fine-scale grid cells or layers with similar property values to maintain heterogeneity of the reservoir model thereby improving reliability of the coarse-scale model as compared with a coarse model upgridded based on the structure of the fine-scale grid alone.

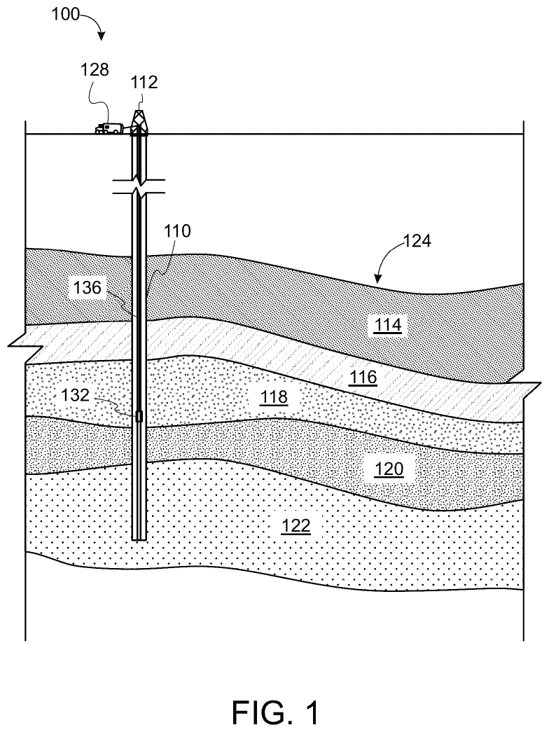

FIG. 1 illustrates an example wireline operation 100 (e.g., a well logging operation) through which properties of the subsurface formation 124 can be measured. The measured properties can subsequently be incorporated into geological and reservoir models that can be used to identify locations of hydrocarbons within the subsurface formation 124 and/or improve hydrocarbon extraction and production activities. Example properties that can be measured in the wireline operation 100 include oil saturation, water saturation, rock porosity, and permeability.

The wellbore 110 is a vertical wellbore that extends downhole from a wellhead 112. Wireline operations can also be performed in other wellbores, for example, slanted or horizontal wellbores. In the wireline operation 100, the wellbore 110 penetrates through five layers 114, 116, 118, 120, 122 of the subsurface formation 124. A control truck 128 lowers a logging tool 132 (e.g., a porosity logging tool) down the wellbore 110 on a wireline 136.

The logging tool 132 is a string of one or more instruments with sensors operable to measure petrophysical properties of the subsurface formation 124. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which is typically a function of lithology and rock texture but particularly porosity. The logging tool includes a piezoelectric transmitter and receiver and the time taken for the sound wave to travel the fixed distance between the two is recorded as an interval transit time.

As the logging tool 132 travels downhole, measurements of formation properties are recorded to generate a well log. In the illustrated operation, the data are recorded at the control truck 128 in real-time. Real-time data are recorded directly against measured cable depth. In some well-logging operations, the data is recorded at the logging tool 132 and downloaded later. In this approach, the downhole data and depth data are both recorded against time The two data sets are then merged using the common time base to create an instrument response versus depth log.

In the wireline operation 100, the well logging is performed on a wellbore 110 that has already been drilled. In some operations, well logging is performed in the form of logging while drilling techniques. In these techniques, the sensors are integrated into the drill string and the measurements are made in real-time, during drilling rather than using sensors lowered into a well after drilling.

Using a wireline coring tool, core samples can be obtained in addition to obtaining well logs. A core sample is a usually cylindrical piece of the subsurface formation that is removed by a special drill and brought to the surface. Core samples can be used to measure petrophysical properties of the subsurface formation such as grain size, porosity, permeability, and unconformity. Core samples can be taken from the sidewalls of a drilled well. When sidewall core samples are repeated along the length of the well, the properties measured from the core samples can be compared and correlated with well logging measurements.

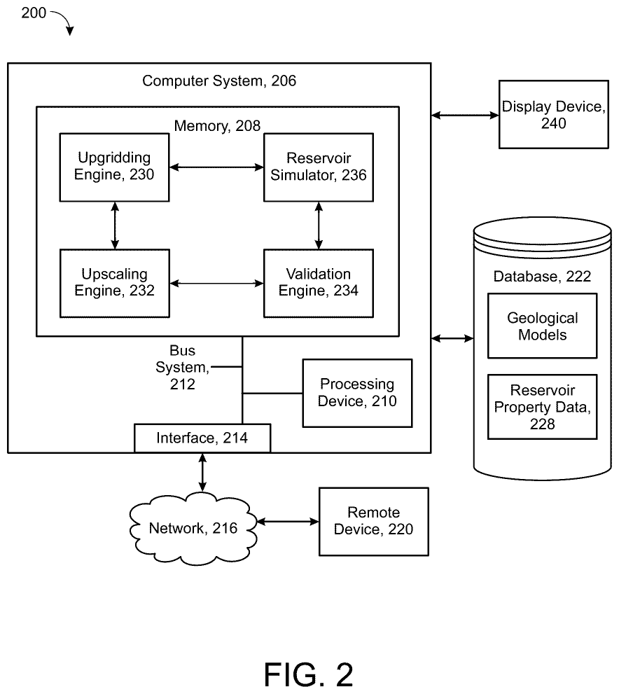

FIG. 2 is a block diagram of an example system 200 for upgridding a reservoir model of a subsurface formation. System 200 includes a computer system 206 that includes a memory 208, processing device 210, bus system 212, and interface 214. The memory 208 includes an upgridding engine 230, an upscaling engine 232, a validation engine 234, and a reservoir simulator 236. The computer system 206 can connect to a remote device 220 (e.g., to transmit or receive data) through a network 216. The network 216 can be a wired or wireless network. The computer system 206 is also communicatively coupled to a database 222. The database 222 can include data such as geological models 224 and reservoir property data 228.

The upgridding engine 230 obtains a fine-scale geological model 224 and reservoir property data 228 associated with the geological model 224 from the database 222. The upgridding engine generates a coarse grid based on the reservoir property data 228 and the fine-scale geological model 224. The upgridding engine 230 can normalize the reservoir properties associated with the fine-scale grid. For example, the upgridding engine can subtract a mean property value from each element in the fine-scale grid and divide by the standard deviation of the property. The upgridding engine 230 can reshape the fine-scale grid to reduce a dimensionality of the fine-scale grid. For example, the upgridding engine 230 can reshape a fine-scale grid from a three-dimensional grid (n_x×n_y×n_z) to a two dimensional grid (n_z×n_l, where n_l=n_x*n_y) by reordering the horizontal (e.g., areal) dimensions of the grid. The upgridding engine 230 can determine a normalized graph Laplacian of the fine-scale grid based on the reshaped and normalized reservoir properties. The normalized graph Laplacian, for example, represents connections between adjacent cells in the fine-scale grid that are a part of the same geological reservoir zone. The upgridding engine 230 can determine characteristic vectors and values of the graph Laplacian. The upgridding engine 230 can cluster the characteristic vectors to determine layers of the fine-scale grid that can be merged to form the coarse grid. The upgridding engine 230 can receive a specified number of clusters corresponding with a specified number of layers in the coarse grid. For example, the upgridding engine 230 can receive the specified number of clusters from a user. Based on the identified clusters, the upgridding engine 230 can generate the coarse grid with the specified number of layers.

The upscaling engine 232 receives the coarse grid from the upgridding engine 230. The upscaling engine 232 maps the reservoir property data associated with cells in the fine-scale geological model to the coarse grid. For example, the upscaling engine 232 can average properties from cells in the fine-scale geological model that are merged into a single cell in the coarse grid. The cells in the fine-scale grid that are merged are indicated by the clusters formed from the characteristic vectors.

The validation engine 234 compares the fine-scale geological model and the upscaled coarse grid to determine a quality of the coarse grid. For example, the validation engine 234 determines quality metrics to measure the heterogeneity of the subsurface formation represented by the coarse grid as compared with the heterogeneity of the subsurface formation represented by the fine-scale grid. The quality metrics can be used to determine a level of coarseness that sufficiently preserves the heterogeneity of the subsurface formation for the reservoir simulations.

The reservoir simulator 236 receives the coarse grid and performs a reservoir simulation using the coarse grid. The reservoir simulation can be used to determine locations in the subsurface formation that contain hydrocarbons that can be produced to the surface. For example, the reservoir simulation can be used to determine an optimal trajectory or location of new wells to drill into the reservoir, to predict or optimize hydrocarbon recovery and well reservoir production performance, and/or to determine well control schedules to minimize production of undesirable fluids (e.g. water) from the subsurface formation.

In some implementations, the upgridding engine 230 generates multiple realizations of coarse grids that can be used in different stages of reservoir simulations by the reservoir simulator 236. For example, during early stages of reservoir model history matching, the reservoir simulator 236 can use very coarse realizations sacrificing heterogeneity in the reservoir simulation in favor of speeding up the history matching process. During later stages of history matching, e.g., after acceptable or near-acceptable solutions have been found using the very coarse realizations, the reservoir simulator 236 can use less coarse realizations to include important geological details in the final history matched simulation model.

The computer system 206 can render for display on display device 240 intermediate results and/or end results from each of the engines 230-236. For example, the computer system 206 can render for display one or more of the fine-scale geological model, a coarse grid realization, an upscaled reservoir model, quality metrics from the coarse grid realizations, and reservoir simulations.

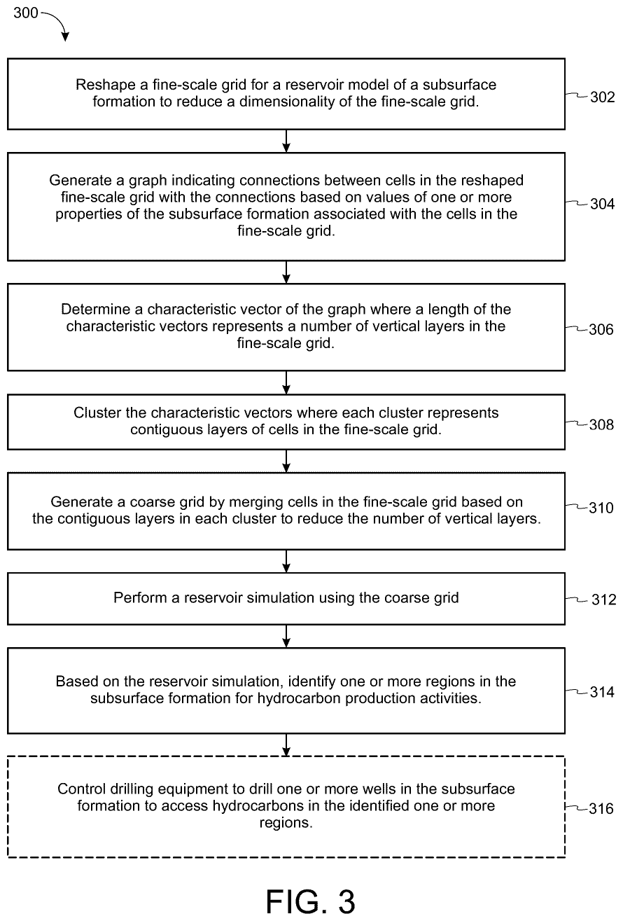

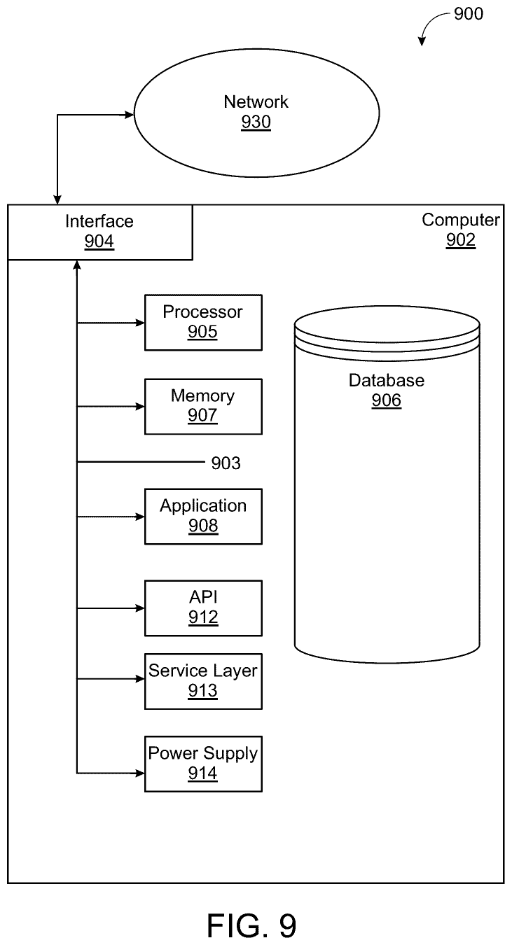

FIG. 3 is a flowchart for an example method 300 for upgridding a subsurface reservoir model. The method 300 can be implemented on a data processing system such as a computer or control system (e.g., computer system 206 or the computer system of FIG. 9).

The data processing system reshapes a fine-scale grid for a reservoir model of a subsurface formation to reduce a dimensionality of the fine-scale grid (step 302). The fine-scale grid can be a 3D grid with vertical (z) and areal (x and y) dimensions. The data processing system obtains the fine-scale grid and properties associated with the cells in the fine-scale grid from, for example, a hardware storage device. The data processing system an reshape the fine-scale grid by using a linear representation to reference the areal dimensions of the grid. For example, each cell in a particular vertical layer can be assigned a unique number to reference that cell. In so doing, the dimensionality of the grid is reduced because a cell in a particular layer can be referenced by a single coordinate rather than by two coordinates (e.g., x and y values). The data processing system can represent the reshaped fine-scale grid as an n_z×n_l array, where n_z represents the number of vertical layers and n_l represents the product of the number of cells in the x and y dimensions (n_x×n_y). The data processing system can similarly reshape the array of property values associated with the cells of the fine-scale grid. In some implementations, the data processing system normalizes the property values by subtracting the mean value of the property from each element in the array and dividing by the standard deviation of the property value.

The data processing system generates a graph indicating connections between cells in the reshaped fine-scale grid (step 304). The connections are based on the values of one or more properties of the subsurface formation associated with the cells in the fine-scale grid. For example, the data processing system can determine a normalized graph Laplacian of the fine-scale grid based on the property values. The data processing system determines an adjacency matrix, A, and a degree matrix, D, based on the property values. The adjacency matrix indicates whether two layers are connected, and the degree matrix indicates information about each layer (e.g., the number of other layers connected to a particular layer or a strength of connection). In some implementations, the data processing system determines whether two adjacent vertical layers in the fine-scale grid are in the same geological zone. If the two layers are in the same geological zone, the data processing system determines a connection value to add to the adjacency matrix and degree matrix for those layers. If the two layers are not in the same geological zone, then the data processing system determines that there is no connection between the layers and no values are added to the adjacency matrix and degree matrix. A geological zone is, for example, an interval of reservoir rock whose characteristics are different from those of adjoining rocks. Geological zones can be determined from seismic and well log data, as well as lithostratigraphic, chemostratigraphic and biostratigraphic datasets. Determination of geological zones can precede the formation of the coarse grid realizations. For example, the data processing system can determine the geological zones during the construction of the input fine-scale geostatic grid by a geomodeller. Forming connections in the graph between layers that are in the same geological zone while not forming connections between layers in different geological zones is advantageous to preserve a heterogenous representation of the subsurface formation.

In some implementations, the connection value for the adjacency and degree matrices is determined based on a difference between property values in the layers. For example, the data processing system can move element by element through the two layers to determine the difference in the property values between the layers. (e.g., δ=Z_v (i)−Z_w (i), i=1 . . . n_l, where Z_v “and” Z_w are vectors of properties for the adjacent layers v and w in the fine-scale grid). The data processing system can determine the connection value for the adjacency and degree matrices based on this difference (e.g., s=s+e\hat{ }(−0.5δ\hat{ }2) ). The data processing system can then store the connection value in the adjacency and degree matrices at the locations corresponding to the two layers (e.g., A(v,w)=A(w,v)=s; D(v,v)=D(v,v)+s; D(w,w)=D(w,w)+s). After iterating through each of the vertical layers in the fine-scale grid, the data processing system can determine the normalized graph Laplacian based on the adjacency and degree matrices (e.g., L_s=I−D\hat{ }(−1) A).

The data processing system determines characteristic vectors of the graph where a length of the characteristic vectors represents a number of vertical layers in the fine-scale grid (step 306). The characteristic vectors can be, for example, eigenvectors of the graph (e.g., normalized graph Laplacian, L_s). The data processing system can also determine corresponding characteristic values (e.g., eigenvalues). In some implementations, the data processing system stores the characteristic vectors according to the characteristic value (e.g., sorted in a matrix by the magnitude of the characteristic value).

The data processing system clusters the characteristic vectors (step 308). Each cluster represents contiguous layers of cells in the fine-scale grid. For example, the data processing system can cluster the characteristic vectors using a k-means technique where the number of clusters corresponds to a desired number of vertical layers in a coarse grid. In some implementations, the data processing system clusters a subset of the characteristic vectors. For example, the data processing system can select the first c vectors with nonzero characteristic values such that two to the c power is greater than the desired number of layers (e.g., V\hat{ }*⊂V, where V is a matrix of the characteristic vectors sorted by characteristic value and c is the smallest integer such that 2\hat{ }c≥r where r is the desired number of layers). The characteristic vectors can be concatenated to form the matrix V. In some implementations, the data processing system clusters the characteristic vectors based on rows in the characteristic vector matrix, V or V\hat{ }*. In such implementations, the length of the row vectors corresponds to the number of characteristic vectors in V or V\hat{ }*.

The data processing system generates a coarse grid by merging cells in the fine-scale grid based on the contiguous layers in each cluster to reduce the number of vertical layers (step 310). For example, the clusters can indicate which layers in the fine-scale grid to merge together to form a single vertical layer in the coarse grid. The number of layers in the coarse grid should be equal to or greater than the number of unique geological zones in the subsurface formation in order to preserve heterogeneity of the subsurface formation in the coarse grid.

In some implementations, the data processing system generates multiple coarse grid realizations by iteratively clustering the characteristic vectors with different specified numbers of clusters. For example, the data processing system can determine coarse grid realizations based on a minimum number of layers to include in the coarse grid and up to a maximum number of layers desired in the coarse grid.

The data processing system can determine quality metrics associated with the clustering of the characteristic vectors for each iteration. The quality metrics indicate deviations of values of the one or more average properties for contiguous layers of cells corresponding to clusters compared with the values of the one or more properties associated with corresponding cells in the fine-scale grid. For example, the quality metric can be a percentage deviation from the property values in the fine-scale grid or a normalized sum of squared differences. The quality metric can be used to compare different coarse grid realizations, and the data processing system can select a coarse grid realization for a reservoir simulation based on the quality metric. For example, the data processing system can select a coarse grid realization having a quality metric that meets a threshold value with the fewest number of vertical layers. Selecting a coarse grid realization with the fewest number of vertical layers is advantageous to reduce reservoir simulation run time and computational resource requirements as compared with a coarse grid with more vertical layers. In some implementations, the data processing system selects a coarse grid realization with a worse quality metric (e.g., higher deviation from the fine-scale grid) and a fewer number of vertical layers during early stages of reservoir simulations (e.g., early history matching). At later stages of the reservoir simulations when more detail is desired in the simulation results, the data processing system can select a coarse grid realization with a better quality metric and correspondingly more vertical layers.

The data processing system performs a reservoir simulation using the coarse grid (step 312). A reservoir simulation can, for example, predict fluid movement in the subsurface in response to applied boundary conditions. The reservoir simulations can be used to predict future reservoir performance in response to hydrocarbon production and exploration activities. The reservoir simulation can be calibrated through a history matching process using past measured performance of the reservoir.

The data processing system identifies one or more regions in the subsurface formation for hydrocarbon production activities based on the reservoir simulation (step 314). The one or more regions are locations within the subsurface formation that have properties associated with a presence of hydrocarbons. The one or more regions can include, for example, regions where a new well can be drilled into the subsurface formation to access the reservoir, regions where new sidetracks from existing wells can be drilled, and/or regions where enhanced oil recovery techniques can be used to extract hydrocarbons through existing wells. The data processing system can identify regions to improve hydrocarbon recovery and well reservoir production performance and/or to determine well control schedules to minimize production of undesirable fluids (e.g. water) from the subsurface formation.

In some implementations, the data processing system controls drilling equipment to drill wells at the one or more identified regions in the subsurface formation (step 316). For example, the data processing system can generate control commands for the drilling equipment (on-site or remotely) based on the reservoir simulation using one or more coarse grids.

In some implementations, the data processing system controls hydrocarbon production equipment to produce hydrocarbons from the one or more identified regions in the subsurface formation based on the reservoir simulations. For example, the data processing system can generate control commands for the production equipment (on-site or remotely).

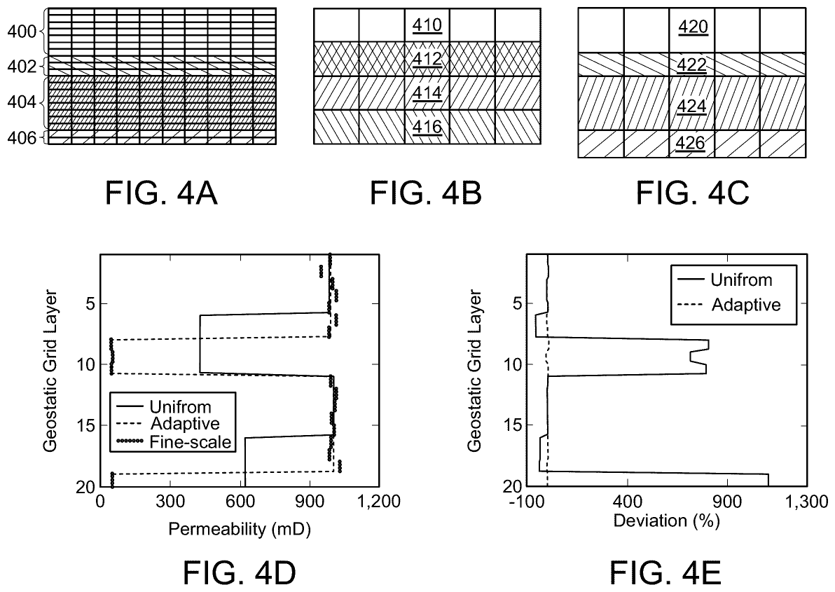

FIGS. 4A-4E illustrate a comparison between a coarse grid formed through uniform upgridding and a coarse grid formed using the adaptive upgridding described herein (e.g., method 300). FIG. 4A is an example two-dimensional (2D) fine-scale geostatic grid with 20 vertical layers. There are four geological zones 400, 402, 404, 406. Zones 402 and 406, corresponding to layers 8 to 10 and layers 19 and 20, have low permeability values while zones 400 and 404 have high permeability values. The permeability values are represented by the shading of the cells in the grid.

FIG. 4B is a coarse grid with four vertical layers formed through uniform upgridding followed by upscaling to populate the geological properties in the coarse grid. In the uniform upgridding process, the number of layers in the fine-scale grid are merged evenly into the desired number of vertical layers in the coarse grid without regard to the properties of the subsurface. In FIG. 4B, each layer 410, 412, 414, 416 corresponds to a block of 5 layers from the fine-scale grid. During the upscaling process, the property values from the 5 layers of the fine-scale grid are averaged to determine the property value of the corresponding layer 410-416 in the coarse grid. This causes the low permeability zones to increase in vertical height and increase in permeability because the low permeability zones 402, 406 are averaged with a portion of the high permeability zones 400, 404.

FIG. 4C is a coarse grid with four vertical layers formed through an adaptive upgridding process as described herein. This adaptive upgridding considers the properties in the 20-layer geostatic grid and groups geostatic grid layers with similar properties into the same coarse simulation grid layers and vice versa. The adaptive upgridding method provides coarse grid properties that much better match those of the input geostatic grid. In this case, the geological zones 400-406 correspond with the layers 420-426 in the coarse grid. Although the vertical height of each of the layers is no longer uniform (as compared with the fine-scale grid), the heterogeneity of the subsurface is preserved because the layers 420-426 have height and property values equivalent to the layers 400-406.

FIGS. 4D and 4E show plots of permeability (FIG. 4D) for each of the grids of FIGS. 4A-4C and deviations of properties (FIG. 4E) of the coarse grids of FIGS. 4B and 4C compared with the properties of the fine-scale grid in FIG. 4A. The adaptive coarse grid matches the fine-scale grid much better than the uniform coarse grid both in absolute value of the permeability and in percent deviation.

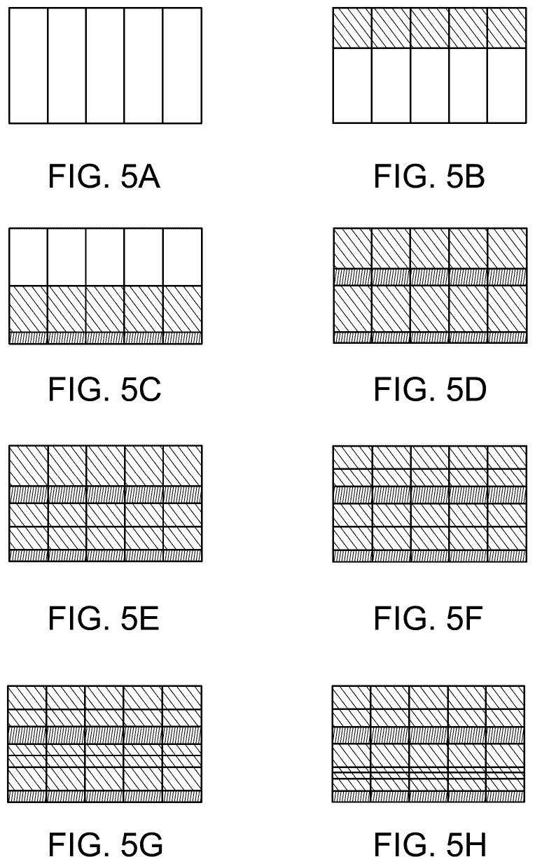

FIGS. 5A-5H illustrate coarse grids with progressively more vertical layers. Because the desired number of vertical layers is rarely known at the beginning of the modeling process, obtaining multiple coarse grid realizations with varying numbers of vertical layers along with a quality metric for each realization is useful to determine the desired number of vertical layers. The coarse grids in FIGS. 5A-5H are upgridded using the adaptive upgridding process and upscaled from the fine-scale grid in FIG. 4A. The number of layers in the coarse grids varies from 1 layer in FIG. 5A to 8 layers in FIG. 5H. The adaptive upgridding enables non-uniform grids that vary based on data from the geostatic grid to represent the heterogeneity of the subsurface formation.

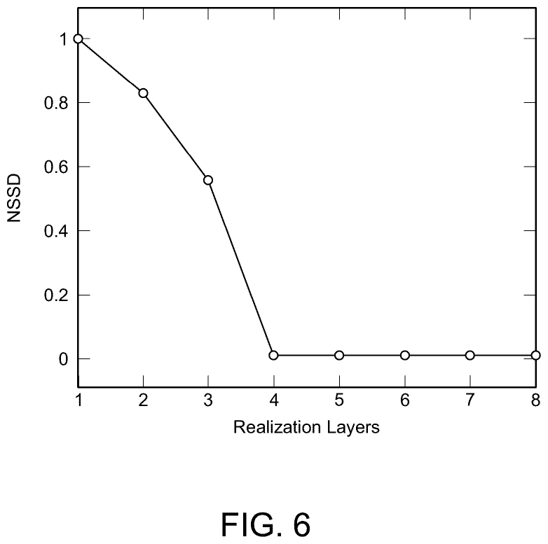

FIG. 6 is a plot of the quality metrics associated with the coarse grids in FIGS. 5A-5H. Here, the normalized sum of squared differences is used as the quality metric to compare the coarse grids with the fine-scale grid. For this example, it is clear that using four layers will provide the best result because there is no further improvement in the quality metric with more than four layers and using the lowest number of layers will be the most computationally efficient. A similar process can be used to determine the number of vertical layers to use in a more complex model than used in this example. In some cases, there may be trade-offs to consider between the quality of the gird and the computational efficiency of executing the reservoir simulation. For example, a slight improvement in the quality metric may not justify executing a coarse grid with a larger number of layers due to the computational cost of the simulation using the grid with more layers.

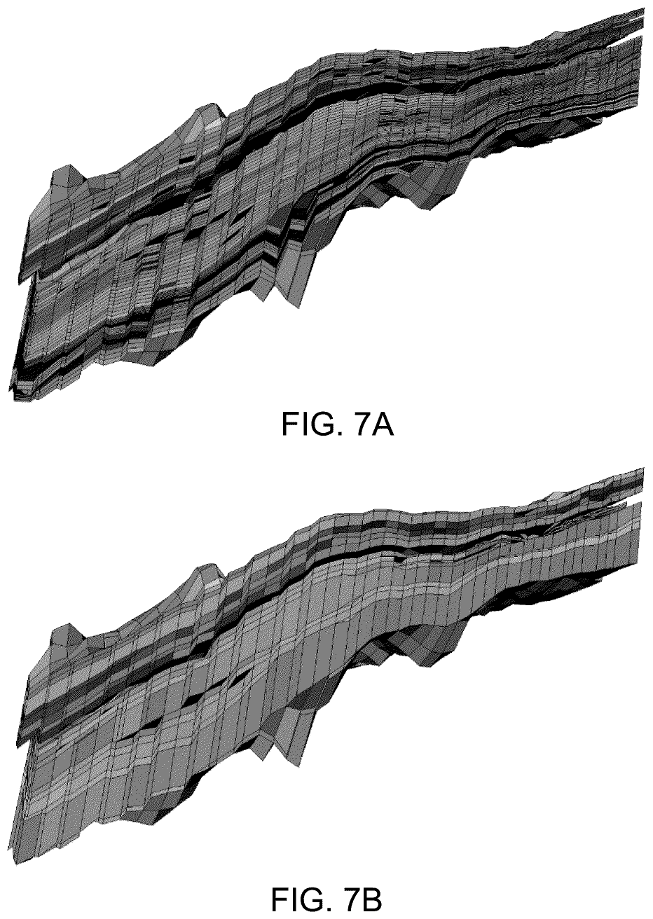

FIG. 7A shows a cross-section from an example application of a 3D geostatic model grid with 64 layers. FIG. 7B shows an adaptive coarse grid realization of the 3D geostatic model using 24 layers. The 24-layer adaptive coarse grid realization preserves the most important geological detail present in the 64-layer geostatic grid, ensuring that reservoir simulation runs on the coarse grid closely match runs on the fine grid.

Due to its ability to effectively preserve geological detail, the adaptive upgridding method can enable more aggressive coarsening, and hence greater simulation runtime speed up, for the same level of reliability of the results, compared to traditional uniform upgridding methods. Alternatively, the adaptive upgridding method can achieve similar levels of coarsening, compared to traditional uniform upgridding methods, but with higher overall coarse grid result reliability.

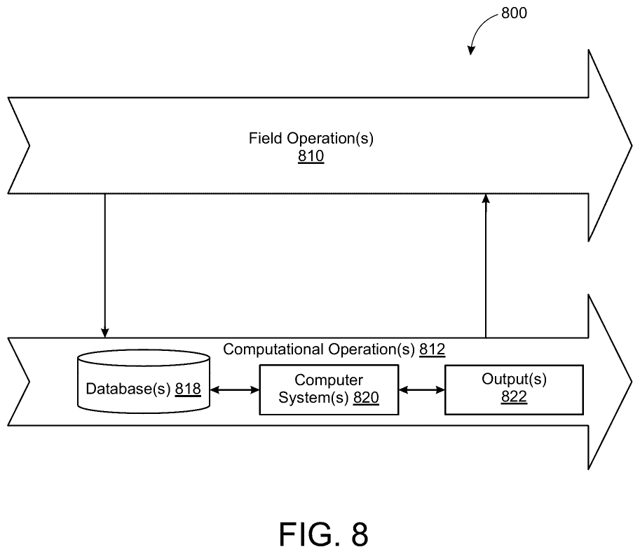

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure (e.g., the method 400) can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively, or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 8 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 9 is a block diagram of an example computer system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 930. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 930 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 903. In some implementations, any or all of the components of the computer 902, including hardware or software components, can interface with each other or the interface 904 (or a combination of both), over the system bus 903. Interfaces can use an application programming interface (API) 912, a service layer 913, or a combination of the API 912 and service layer 913. The API 912 can include specifications for routines, data structures, and object classes. The API 912 can be either computer-language independent or dependent. The API 912 can refer to a complete interface, a single function, or a set of APIs.

The service layer 913 can provide software services to the computer 902 and other components (whether illustrated or not) that are communicably coupled to the computer 902. The functionality of the computer 902 can be accessible for all service consumers using this service layer. Software services, such as those provided by the service layer 913, can provide reusable, defined functionalities through a defined interface. For example, the interface can be software written in JAVA, C++, or a language providing data in extensible markup language (XML) format. While illustrated as an integrated component of the computer 902, in alternative implementations, the API 912 or the service layer 913 can be stand-alone components in relation to other components of the computer 902 and other components communicably coupled to the computer 902. Moreover, any or all parts of the API 912 or the service layer 913 can be implemented as child or sub-modules of another software module, enterprise application, or hardware module without departing from the scope of the present disclosure.

The computer 902 includes an interface 904. Although illustrated as a single interface 904 in FIG. 9, two or more interfaces 904 can be used according to particular needs, desires, or particular implementations of the computer 902 and the described functionality. The interface 904 can be used by the computer 902 for communicating with other systems that are connected to the network 930 (whether illustrated or not) in a distributed environment. Generally, the interface 904 can include, or be implemented using, logic encoded in software or hardware (or a combination of software and hardware) operable to communicate with the network 930. More specifically, the interface 904 can include software supporting one or more communication protocols associated with communications. As such, the network 930 or the interface's hardware can be operable to communicate physical signals within and outside of the illustrated computer 902.

The computer 902 includes a processor 905. Although illustrated as a single processor 905 in FIG. 9, two or more processors 905 can be used according to particular needs, desires, or particular implementations of the computer 902 and the described functionality. Generally, the processor 905 can execute instructions and can manipulate data to perform the operations of the computer 902, including operations using algorithms, methods, functions, processes, flows, and procedures as described in the present disclosure.

The computer 902 also includes a database 906 that can hold data for the computer 902 and other components connected to the network 930 (whether illustrated or not). For example, database 906 can be an in-memory, conventional, or a database storing data consistent with the present disclosure. In some implementations, database 906 can be a combination of two or more different database types (for example, hybrid in-memory and conventional databases) according to particular needs, desires, or particular implementations of the computer 902 and the described functionality. Although illustrated as a single database 906 in FIG. 9, two or more databases (of the same, different, or combination of types) can be used according to particular needs, desires, or particular implementations of the computer 902 and the described functionality. While database 906 is illustrated as an internal component of the computer 902, in alternative implementations, database 906 can be external to the computer 902.

The computer 902 also includes a memory 907 that can hold data for the computer 902 or a combination of components connected to the network 930 (whether illustrated or not). Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 (of the same, different, or combination of types) can be used according to particular needs, desires, or particular implementations of the computer 902 and the described functionality. While memory 907 is illustrated as an internal component of the computer 902, in alternative implementations, memory 907 can be external to the computer 902.

The application 908 can be an algorithmic software engine providing functionality according to particular needs, desires, or particular implementations of the computer 902 and the described functionality. For example, application 908 can serve as one or more components, modules, or applications. Further, although illustrated as a single application 908, the application 908 can be implemented as multiple applications 908 on the computer 902. In addition, although illustrated as internal to the computer 902, in alternative implementations, the application 908 can be external to the computer 902.

The computer 902 can also include a power supply 914. The power supply 914 can include a rechargeable or non-rechargeable battery that can be configured to be either user-or non-user-replaceable. In some implementations, the power supply 914 can include power-conversion and management circuits, including recharging, standby, and power management functionalities. In some implementations, the power-supply 914 can include a power plug to allow the computer 902 to be plugged into a wall socket or a power source to, for example, power the computer 902 or recharge a rechargeable battery.

There can be any number of computers 902 associated with, or external to, a computer system containing computer 902, with each computer 902 communicating over network 930. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### Examples

In an example implementation, a method for upgridding a reservoir model for a subsurface formation includes reshaping a fine-scale grid for the reservoir model to reduce a dimensionality of the fine-scale grid; generating a graph indicating connections between cells in the reshaped fine-scale grid. The connections are based on values of one or more properties of the subsurface formation associated with the cells in the fine-scale grid. The method includes determining characteristic vectors of the graph where a length of the characteristic vectors represents a number of vertical layers in the fine-scale grid; clustering the characteristic vectors, Each cluster represents contiguous layers of cells in the fine-scale grid. The method includes generating a coarse grid by merging cells in the fine-scale grid based on the contiguous layers in each cluster to reduce the number of vertical layers; performing a reservoir simulation using the coarse grid; and based on the reservoir simulation, identifying one or more regions in the subsurface formation for hydrocarbon production activities, the one or more regions being locations within the subsurface formation having properties associated with a presence of hydrocarbons.

An aspect combinable with the example implementation includes controlling drilling equipment to drill one or more wells in the subsurface formation to access hydrocarbons in the identified one or more regions.

Another aspect combinable with one, some, or all of the previous aspects includes generating a plurality of coarse grid realizations by iteratively clustering the characteristic vectors, where each iteration includes clustering the characteristic vectors using a different specified number of clusters.

Another aspect combinable with one, some, or all of the previous aspects includes determining quality metrics associated with the clustering of the characteristic vectors for each iteration. The quality metrics indicate deviations of values of the one or more average properties for contiguous layers of cells corresponding to clusters compared with the values of the one or more properties associated with corresponding cells in the fine-scale grid.

Another aspect combinable with one, some, or all of the previous aspects includes selecting a coarse grid realization from the plurality of coarse grid realizations for use in the reservoir simulation based on the quality metrics.

In another aspect combinable with one, some, or all of the previous aspects, the graph includes a normalized graph Laplacian of the fine-scale grid, and the characteristic vectors represent eigenvectors of the normalized graph Laplacian ordered based on eigenvalues of the normalized graph Laplacian.

In another aspect combinable with one, some, or all of the previous aspects, clustering the characteristic vectors includes selecting a subset of the characteristic vectors based on a desired number of layers in the coarse grid; concatenating the subset of characteristic vectors into a matrix with each column representing one characteristic vector; and performing a clustering operation based on row vectors of the matrix.

In another aspect combinable with one, some, or all of the previous aspects, generating the graph comprises determining that a cell in the fine-scale grid is connected to an adjacent cell in the fine-scale grid based on the values of the one or more properties indicating that the cell and the adjacent cell represent a portion of the subsurface formation in a same reservoir geological zone.

In another aspect combinable with one, some, or all of the previous aspects, the clustering the characteristic vectors comprises a k-means clustering operation where a specified number of clusters represents a desired number of vertical layers in the coarse grid.

In another example implementation, a system for upgridding a reservoir model for a subsurface formation includes one or more processors; a hardware storage device; and a computer readable medium storing instructions that when executed cause the one or more processors to perform operations. The operations include reshaping a fine-scale grid for a reservoir model of a subsurface formation to reduce a dimensionality of the fine-scale grid; generating a graph indicating connections between cells in the reshaped fine-scale grid, the connections being based on values of one or more properties of the subsurface formation associated with the cells in the fine-scale grid; determining characteristic vectors of the graph where a length of the characteristic vectors represents a number of vertical layers in the fine-scale grid; clustering the characteristic vectors, where each cluster represents contiguous layers of cells in the fine-scale grid; generating a coarse grid by merging cells in the fine-scale grid based on the contiguous layers in each cluster to reduce the number of vertical layers; performing a reservoir simulation using the coarse grid; and based on the reservoir simulation, identifying one or more regions in the subsurface formation for hydrocarbon production activities, the one or more regions being locations within the subsurface formation having properties associated with a presence of hydrocarbons.

An aspect combinable with the example implementation includes controlling drilling equipment to drill one or more wells in the subsurface formation to access hydrocarbons in the identified one or more regions.

Another aspect combinable with one, some, or all of the previous aspects includes generating a plurality of coarse grid realizations by iteratively clustering the characteristic vectors, where each iteration includes clustering the characteristic vectors using a different specified number of clusters.

Another aspect combinable with one, some, or all of the previous aspects includes determining quality metrics associated with the clustering of the characteristic vectors for each iteration. The quality metrics indicate deviations of values of the one or more average properties for contiguous layers of cells corresponding to clusters compared with the values of the one or more properties associated with corresponding cells in the fine-scale grid. The aspect includes selecting a coarse grid realization from the plurality of coarse grid realizations for use in the reservoir simulation based on the quality metrics.

In another aspect combinable with one, some, or all of the previous aspects, clustering the characteristic vectors includes selecting a subset of the characteristic vectors based on a desired number of layers in the coarse grid; concatenating the subset of characteristic vectors into a matrix with each column representing one characteristic vector; and performing a clustering operation based on row vectors of the matrix.

In another aspect combinable with one, some, or all of the previous aspects, generating the graph includes determining that a cell in the fine-scale grid is connected to an adjacent cell in the fine-scale grid based on the values of the one or more properties indicating that the cell and the adjacent cell represent a portion of the subsurface formation in a same reservoir geological zone.

In another example implementation, one or more non-transitory, machine-readable storage devices storing instructions for upgridding a reservoir model for a subsurface formation, the instructions being executable by one or more processors to cause performance of operations including reshaping a fine-scale grid for a reservoir model of a subsurface formation to reduce a dimensionality of the fine-scale grid; generating a graph indicating connections between cells in the reshaped fine-scale grid, the connections being based on values of one or more properties of the subsurface formation associated with the cells in the fine-scale grid; determining characteristic vectors of the graph where a length of the characteristic vectors represents a number of vertical layers in the fine-scale grid; clustering the characteristic vectors, where each cluster represents contiguous layers of cells in the fine-scale grid; generating a coarse grid by merging cells in the fine-scale grid based on the contiguous layers in each cluster to reduce the number of vertical layers; performing a reservoir simulation using the coarse grid; and based on the reservoir simulation, identifying one or more regions in the subsurface formation for hydrocarbon production activities, the one or more regions being locations within the subsurface formation having properties associated with a presence of hydrocarbons.

An aspect combinable with the example implementation includes controlling drilling equipment to drill one or more wells in the subsurface formation to access hydrocarbons in the identified one or more regions.

Another aspect combinable with one, some, or all of the previous aspects includes generating a plurality of coarse grid realizations by iteratively clustering the characteristic vectors, wherein each iteration includes clustering the characteristic vectors using a different specified number of clusters; determining quality metrics associated with the clustering of the characteristic vectors for each iteration, the quality metrics indicating deviations of values of the one or more average properties for contiguous layers of cells corresponding to clusters compared with the values of the one or more properties associated with corresponding cells in the fine-scale grid; and selecting a coarse grid realization from the plurality of coarse grid realizations for use in the reservoir simulation based on the quality metrics.

In another aspect combinable with one, some, or all of the previous aspects, clustering the characteristic vectors includes selecting a subset of the characteristic vectors based on a desired number of layers in the coarse grid; concatenating the subset of characteristic vectors into a matrix with each column representing one characteristic vector; and performing a clustering operation based on row vectors of the matrix.

In another aspect combinable with one, some, or all of the previous aspects, generating the graph comprises determining that a cell in the fine-scale grid is connected to an adjacent cell in the fine-scale grid based on the values of the one or more properties indicating that the cell and the adjacent cell represent a portion of the subsurface formation in a same reservoir geological zone.

What is claimed is:

1. A method for upgridding a reservoir model for a subsurface formation, the method comprising:
reshaping a fine-scale grid for a reservoir model of a subsurface formation to reduce a dimensionality of the fine-scale grid;
generating a graph indicating connections between cells in the reshaped fine-scale grid, the connections being based on values of one or more properties of the subsurface formation associated with the cells in the fine-scale grid;
determining characteristic vectors of the graph where a length of the characteristic vectors represents a number of vertical layers in the fine-scale grid;
clustering the characteristic vectors, where each cluster represents contiguous layers of cells in the fine-scale grid;
generating a coarse grid by merging cells in the fine-scale grid based on the contiguous layers in each cluster to reduce the number of vertical layers;
performing a reservoir simulation using the coarse grid; and
based on the reservoir simulation, identifying one or more regions in the subsurface formation for hydrocarbon production activities, the one or more regions being locations within the subsurface formation having properties associated with a presence of hydrocarbons.

2. The method of claim 1, further comprising controlling drilling equipment to drill one or more wells in the subsurface formation to access hydrocarbons in the identified one or more regions.

3. The method of claim 1, further comprising:
generating a plurality of coarse grid realizations by iteratively clustering the characteristic vectors,
wherein each iteration comprises clustering the characteristic vectors using a different specified number of clusters.

4. The method of claim 3, further comprising determining quality metrics associated with the clustering of the characteristic vectors for each iteration, the quality metrics indicating deviations of values of one or more average properties for contiguous layers of cells corresponding to clusters compared with the values of the one or more properties associated with corresponding cells in the fine-scale grid.

5. The method of claim 4, further comprising selecting a coarse grid realization from the plurality of coarse grid realizations for use in the reservoir simulation based on the quality metrics.

6. The method of claim 1, wherein the graph comprises a normalized graph Laplacian of the fine-scale grid and the characteristic vectors represent eigenvectors of the normalized graph Laplacian ordered based on eigenvalues of the normalized graph Laplacian.

7. The method of claim 1, wherein clustering the characteristic vectors comprises:
selecting a subset of the characteristic vectors based on a desired number of layers in the coarse grid;
concatenating the subset of characteristic vectors into a matrix with each column representing one characteristic vector; and
performing a clustering operation based on row vectors of the matrix.

8. The method of claim 1, wherein generating the graph comprises determining that a cell in the fine-scale grid is connected to an adjacent cell in the fine-scale grid based on the values of the one or more properties indicating that the cell and the adjacent cell represent a portion of the subsurface formation in a same reservoir geological zone.

9. The method of claim 1, wherein the clustering the characteristic vectors comprises a k-means clustering operation where a specified number of clusters represents a desired number of vertical layers in the coarse grid.

10. A system for upgridding a reservoir model for a subsurface formation, the system comprising:
one or more processors;
a hardware storage device; and
a computer readable medium storing instructions that when executed cause the one or more processors to perform operations comprising:
reshaping a fine-scale grid for a reservoir model of a subsurface formation to reduce a dimensionality of the fine-scale grid;
generating a graph indicating connections between cells in the reshaped fine-scale grid, the connections being based on values of one or more properties of the subsurface formation associated with the cells in the fine-scale grid;
determining characteristic vectors of the graph where a length of the characteristic vectors represents a number of vertical layers in the fine-scale grid;
clustering the characteristic vectors, where each cluster represents contiguous layers of cells in the fine-scale grid;
generating a coarse grid by merging cells in the fine-scale grid based on the contiguous layers in each cluster to reduce the number of vertical layers;
performing a reservoir simulation using the coarse grid; and
based on the reservoir simulation, identifying one or more regions in the subsurface formation for hydrocarbon production activities, the one or more regions being locations within the subsurface formation having properties associated with a presence of hydrocarbons.

11. The system of claim 10, further comprising controlling drilling equipment to drill one or more wells in the subsurface formation to access hydrocarbons in the identified one or more regions.

12. The system of claim 10, further comprising:
generating a plurality of coarse grid realizations by iteratively clustering the characteristic vectors,
wherein each iteration comprises clustering the characteristic vectors using a different specified number of clusters.

13. The system of claim 12, further comprising determining quality metrics associated with the clustering of the characteristic vectors for each iteration, the quality metrics indicating deviations of values of one or more average properties for contiguous layers of cells corresponding to clusters compared with the values of the one or more properties associated with corresponding cells in the fine-scale grid; and
selecting a coarse grid realization from the plurality of coarse grid realizations for use in the reservoir simulation based on the quality metrics.

14. The system of claim 10, wherein clustering the characteristic vectors comprises:
selecting a subset of the characteristic vectors based on a desired number of layers in the coarse grid;
concatenating the subset of characteristic vectors into a matrix with each column representing one characteristic vector; and
performing a clustering operation based on row vectors of the matrix.

15. The system of claim 10, wherein generating the graph comprises determining that a cell in the fine-scale grid is connected to an adjacent cell in the fine-scale grid based on the values of the one or more properties indicating that the cell and the adjacent cell represent a portion of the subsurface formation in a same reservoir geological zone.

16. One or more non-transitory, machine-readable storage devices storing instructions for upgridding a reservoir model for a subsurface formation, the instructions being executable by one or more processors to cause performance of operations comprising:
reshaping a fine-scale grid for a reservoir model of a subsurface formation to reduce a dimensionality of the fine-scale grid;
generating a graph indicating connections between cells in the reshaped fine-scale grid, the connections being based on values of one or more properties of the subsurface formation associated with the cells in the fine-scale grid;
determining characteristic vectors of the graph where a length of the characteristic vectors represents a number of vertical layers in the fine-scale grid;
clustering the characteristic vectors, where each cluster represents contiguous layers of cells in the fine-scale grid;
generating a coarse grid by merging cells in the fine-scale grid based on the contiguous layers in each cluster to reduce the number of vertical layers;
performing a reservoir simulation using the coarse grid; and
based on the reservoir simulation, identifying one or more regions in the subsurface formation for hydrocarbon production activities, the one or more regions being locations within the subsurface formation having properties associated with a presence of hydrocarbons.

17. The one or more non-transitory, machine-readable storage devices of claim 16, further comprising controlling drilling equipment to drill one or more wells in the subsurface formation to access hydrocarbons in the identified one or more regions.

18. The one or more non-transitory, machine-readable storage devices of claim 16, further comprising:
generating a plurality of coarse grid realizations by iteratively clustering the characteristic vectors, wherein each iteration comprises clustering the characteristic vectors using a different specified number of clusters;
determining quality metrics associated with the clustering of the characteristic vectors for each iteration, the quality metrics indicating deviations of values of one or more average properties for contiguous layers of cells corresponding to clusters compared with the values of the one or more properties associated with corresponding cells in the fine-scale grid; and
selecting a coarse grid realization from the plurality of coarse grid realizations for use in the reservoir simulation based on the quality metrics.

19. The one or more non-transitory, machine-readable storage devices of claim 16, wherein clustering the characteristic vectors comprises:
selecting a subset of the characteristic vectors based on a desired number of layers in the coarse grid;
concatenating the subset of characteristic vectors into a matrix with each column representing one characteristic vector; and
performing a clustering operation based on row vectors of the matrix.

20. The one or more non-transitory, machine-readable storage devices of claim 16, wherein generating the graph comprises determining that a cell in the fine-scale grid is connected to an adjacent cell in the fine-scale grid based on the values of the one or more properties indicating that the cell and the adjacent cell represent a portion of the subsurface formation in a same reservoir geological zone.
